(19) United States
(12) Patent Application Publication
(10) Pub. No.: US 2002/0089844 A1
(43) Pub. Date: Jul. 11, 2002

(54) Lamp device which is worn on the head

(76) Inventor: Bernhard Strehl, Neu-Seiersberg (AT)

Correspondence Address: Stephen A. Soffen, DICKSTEIN SHAPIRO MORIN & OSHINSKY LLP, 2101 L Street NW, Washington, DC, 20037-1526, US

(21) Appl. No.: 10/084,980

(22) Filed: Mar. 1, 2002

Related U.S. Application Data
(63) Continuation of application No. PCT/AT00/00226, filed on Aug. 25, 2000.

(30) Foreign Application Priority Data
Sep. 2, 1999 (AT) A 1517/99

(51) Int. Cl. F21V 21/084; F21V 21/30

(52) U.S. Cl. 362/105; 362/250; 362/419; 362/427

(57) ABSTRACT

The invention relates to a lamp device which is worn on or directly in front of the forehead, respectively, or above or beside the eyes, respectively, and which ensures that the wearer's freedom of movement is neither restricted nor hindered by cables or other connections. The present invention is special in that several non-thermal, light-emitting elements are provided for the generation of light and that the individual light-emitting elements emit the light in a defined direction of radiation and are located in such a way that the light which is generated is directional. Those light-emitting elements (1) are located in such a way that each of them forms a particular angle with the visual axis of the wearer so that all light sources (1) have a common intersection point just at the wearer's monitoring or working distance, respectively. Moreover, all individual light-emitting elements (1) have the same distance to that intersection point. Furthermore, the vertical position of the area of illumination may be varied in front of the wearer's face.

### DESCRIPTION

The invention relates to a lamp device which is worn on or directly in front of the forehead, respectively, or above or beside the eyes, respectively, f.i., for medical applications in order to illuminate an area of treatment, comprising an integrated energy supply device, characterized in that several non-thermal, light-emitting elements are provided as a light source and that the individual light-emitting elements emit the light in a defined direction of radiation and are located in such a way that the light which is generated is directional.

The subject matter of the invention is a lamp which is worn on or directly in front of the forehead, respectively, or above or beside the eyes, respectively, and which ensures that the wearer's freedom of movement is neither restricted nor hindered by cables or other connections. Such a lamp is intended, f.i., for medical applications in order to illuminate the area of treatment during diagnosis or treatment. However, the lamp is also usable for non-medical applications involving similar problems of illumination.

Lamps and lamp decives worn on the head were designed in various embodiments, in particular for medicine. Thereby, the light is generated either a) directly in front of or on the head of the wearer, or b) in an external light source and is conducted via light guides made of glass, a synthetic material or a liquid to the side of the wearer's forehead. In case of b), the wearer's freedom of movement is more or less hindered or restricted, respectively, by the optical cable, and the weight of the light guide creates an unpleasant drawing stress leading to muscle strains in the back of the neck, to headaches or to other premature symptoms of fatigue. In case of a), cablefree sources of energy, which allow the wearer to move his head unrestrictedly, are indeed also used but the light sources used are of a thermal nature, which leads to a substantial heat development in front of and above the wearer's forehead. Furthermore, the process of light generation takes place with small efficiency so that the packages of accumulators or the batteries, which usually are used, are relatively heavy, which again leads to the above-mentioned symptoms of fatigue. In addition, the light coming from the thermal light sources must first be concentrated by means of suitable optical instruments, which causes those headlamps to have relatively large weights and inconvenient dimensions.

### BRIEF DESCRIPTION

It is the object of the invention to avoid the above-described insufficiencies of conventional headlamps, and the invention is characterized in that several non-thermal, light-emitting elements are provided as a light source and that the individual light-emitting elements emit the light in a defined direction of radiation and are located in such a way that the light which is generated is directional. Thus, it is advantageous that

1. the generation of light occurs directly on the head, i.e. in front of the forehead, above the eyes or beside the eyes of the wearer, by means of non-thermal, light-emitting elements. Preferably, those light sources are designed as light-emitting semiconductors whose radiation is modified such that the human eye receives an impression of white light. On the one hand, that guarantees high efficiency during the transformation of electric energy into light, and, on the other hand, the radiation of light is strongly directional, due to the mode of action and the structure of those light-emitting semiconductors. That directionality of the radiated light is utilized in the present invention, that is, in so far as

2. several of those light-emitting elements are used, which

3. are located in such a way that the direction of radiation of each individual light-emitting element forms an angle with the visual axis of the wearer in such a manner that the centre axis of radiation of all light-emitting elements has a common intersection point on the plane of symmetry of the wearer's eyes at the desired monitoring or working distance, respectively, and

4. the distance of the individual light-emitting elements to that common intersection point is equal for all elements, und furthermore

5. the light-emitting elements are mounted such that the wearer may adapt the level of position of the illumination field generated in accordance with items 2. to 4. to his monitoring or working requirements, respectively.

The above-mentioned features and advantageous characteristics of the headlamp of the invention become even more apparent from the attached drawings of preferred basic arrangements and several preferred embodiments. In detail, the drawings depict the following:

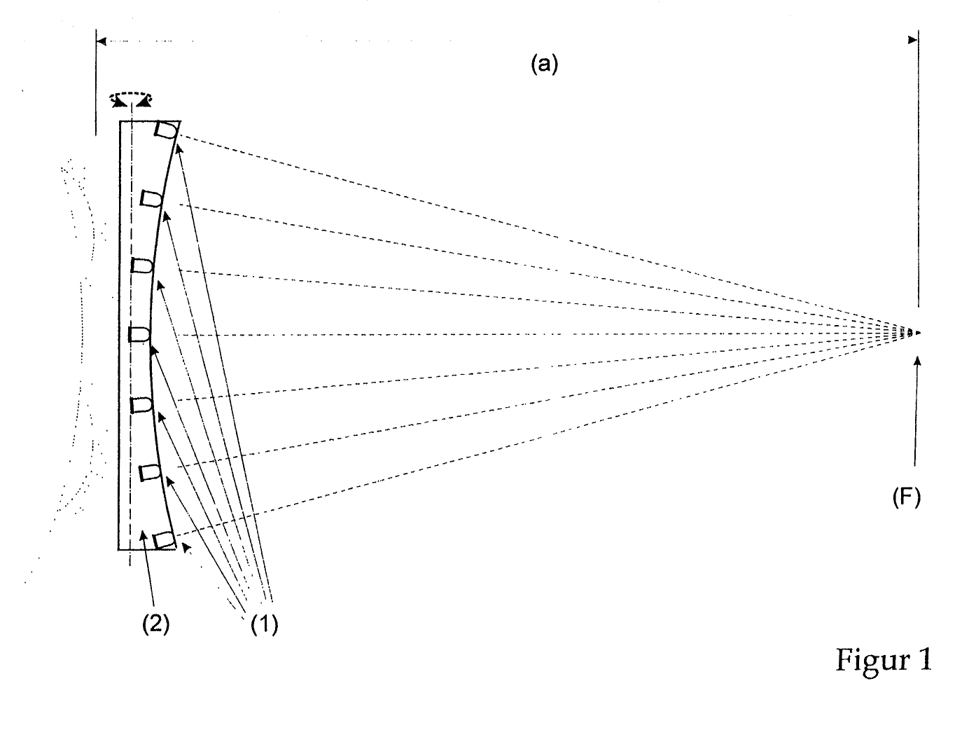

FIG. 1: A preferred basic arrangement of the light-emitting elements (1) above the eyes on a support piece (2) in such a way that the centre axes of ratiation of the light-emitting elements have a common intersection point (F) on the plane of symmetry of the wearer's eyes. Thereby, the mounting of the light-emitting elements (1) on the support piece (2) may be effected such that the distance (a) of the intersection point (F) to the wearer's eyes may be varied. The support piece (2) is rotatable around an axis at a right angle to the plane of symmetry of the eyes.

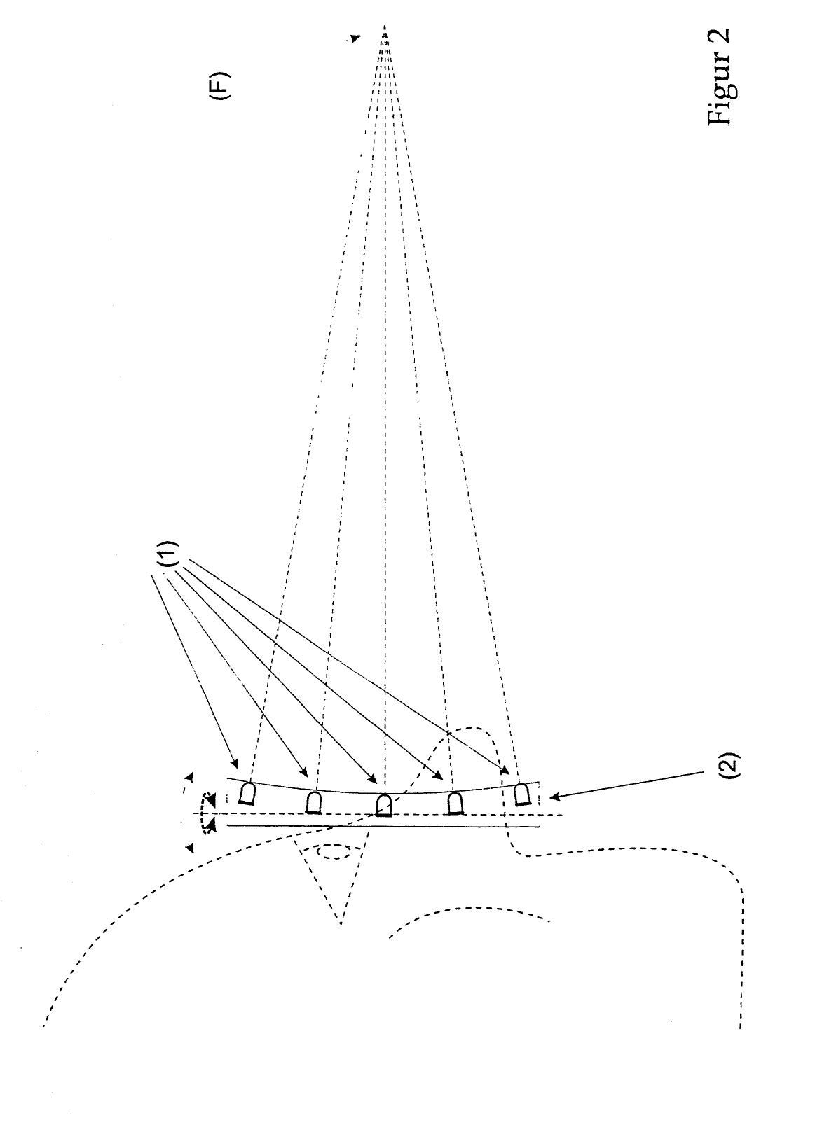

FIG. 2: A further preferred basic arrangement of the light-emitting elements (1) beside the eyes on a support piece (2) on the left-hand side or on the right-hand side or on two support pieces (2) on the left-hand side and on the right-hand side. The centre axes of radiation of all light-emitting elements also have a common intersection point (F) on the plane of symmetry of the wearer's eyes. The support piece(s) (2) is/are mounted to be rotatable around a vertical axis and, additionally, to be inclinable around a horizontal axis.

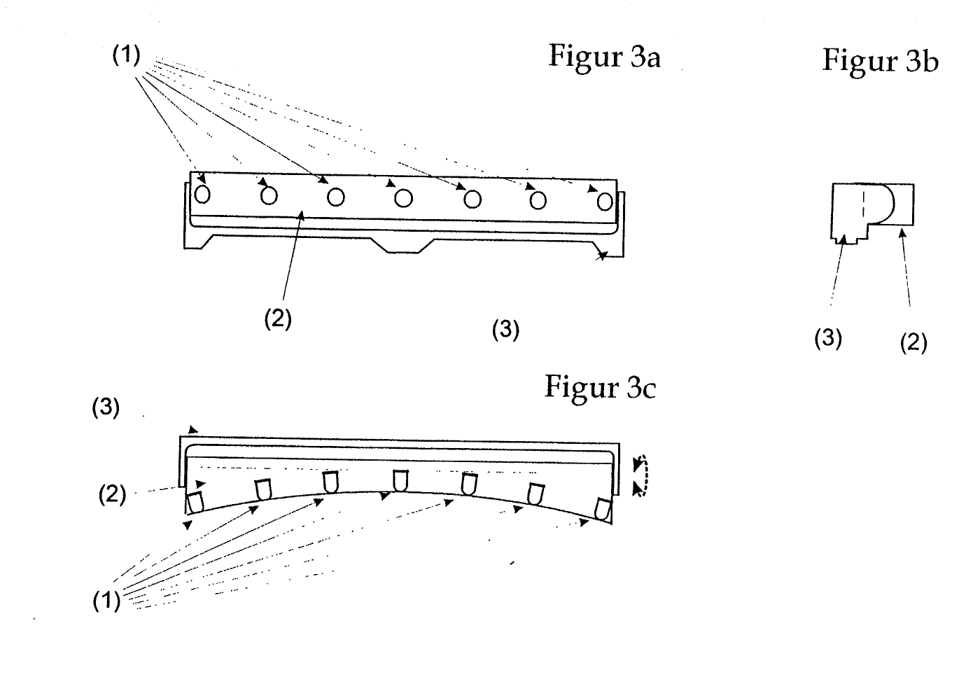

FIG. 3: A preferred embodiment in which the arrangement of the light-emitting elements (1) is achieved in that they are mounted on a support piece (2), which is mounted to a further holding piece (3) in a vertically pivotable fashion, which itself may be fastened in a detachable manner to the upper rim of spectacles or of an eye shield. The current supply device and the switch are housed in an external housing, which, f.i., is worn on the wearer's belt.

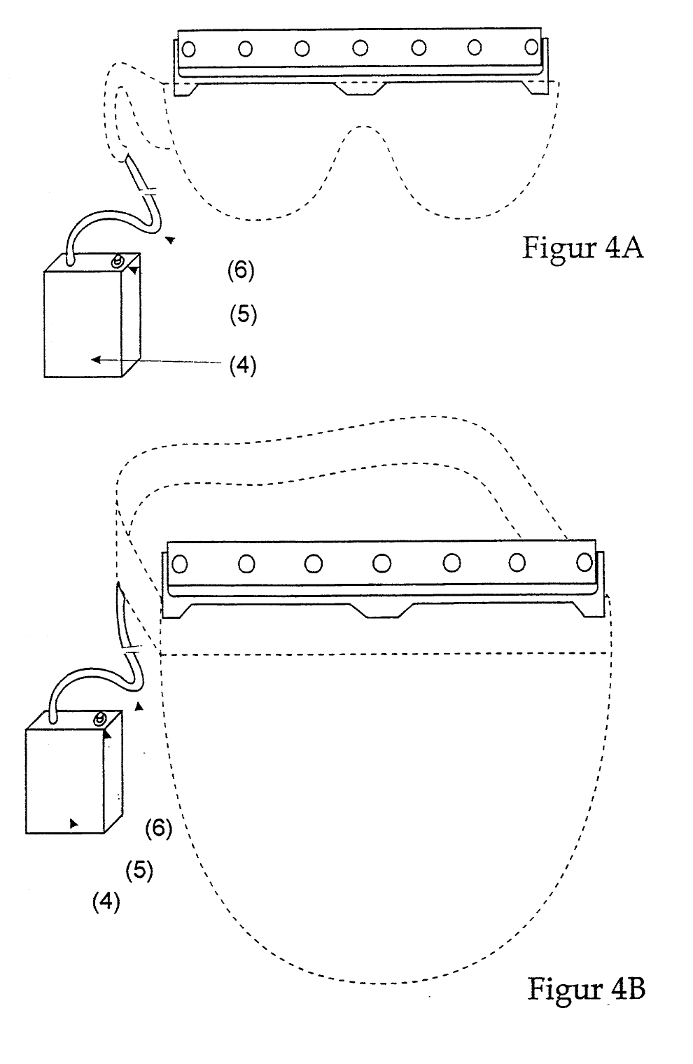

FIG. 4: shows two possible variants of fastening the preferred embodiment depicted in FIG. 3. Partial picture A shows fastening to the upper rim of spectacles, which may be effected by clipping. The current supply device (4) and the switch (5) are housed in an external housing, which, f.i., is worn on the wearer's belt. Current supply takes place via a line (6) which is conducted along one of the bows of the spectacles. Partial picture B shows fastening to an eye shield, also, f.i, by clipping. Current supply takes place via a line which is conducted in the area of the head along the fastening band of the protective shield.

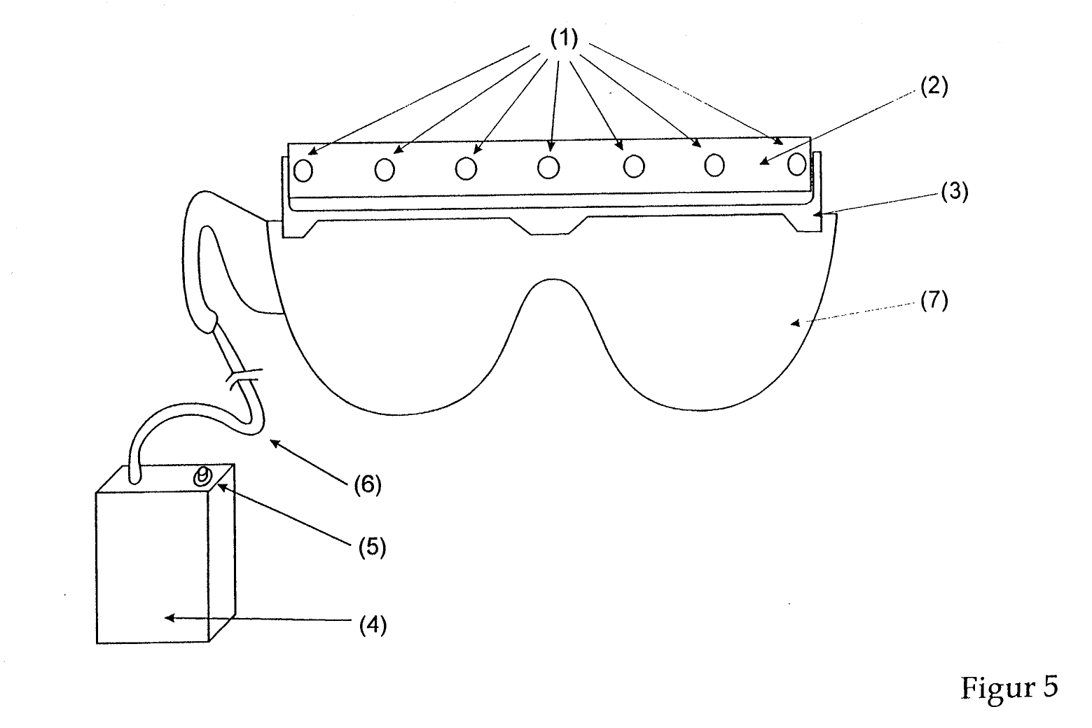

FIG. 5: shows a further preferred embodiment in which the light-emitting elements are fastened to the upper rim of spectacles (7). That kind of fastening is nondetachable so that the lamp and the spectacles (7) form a unit. The light-emitting elements (1) are mounted to a support piece (2), which is mounted to a further holding piece (3) in a vertically pivotable fashion. The holding piece (3) is securely fixed to the upper spectacle frame (7). The current supply device (4) and the switch (5) are housed in an external housing, which, f.i., is worn on the wearer's belt. Current supply takes place via a line (6) which is conducted along one of the bows of the spectacles.

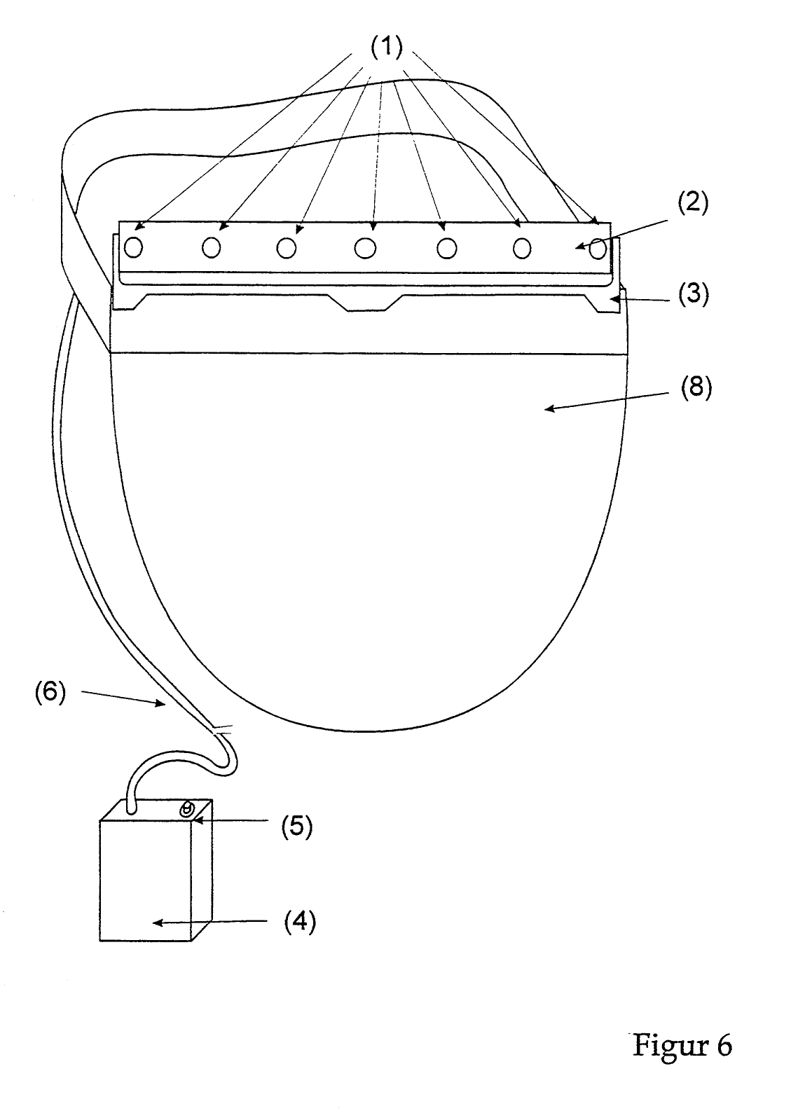

FIG. 6: shows a further preferred embodiment in which the light-emitting elements are fastened to the upper rim of an eye shield (8). That kind of fastening is nondetachable so that the lamp and the eye shield (8) form a unit. The light-emitting elements (1) are mounted to a support piece (2), which is mounted to a further holding piece (3) in a vertically pivotable fashion. The holding piece (3) is securely fixed to the upper rim of the eye shield (8). The current supply device (4) and the switch (5) are housed in an external housing, which, f.i., is worn on the wearer's belt. Current supply takes place via a line (6) which is in the area of the head along the fastening band of the eye shield.

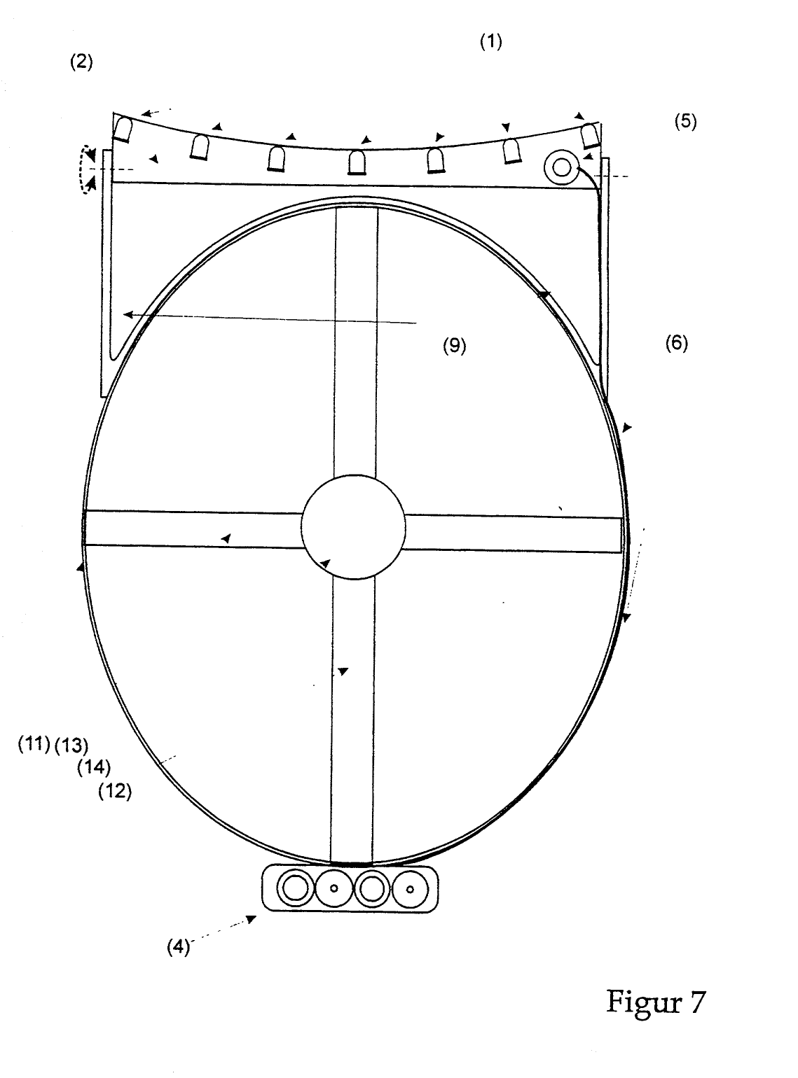

FIG. 7: shows a further preferred embodiment in which the light-emitting elements (1) are mounted to a separate head carrier. The light-emitting elements (1) are mounted to a holding piece (2), which is fastened to a support (9) in such a way that the illumination field may be displaced in a vertical direction and thus may be adapted to the wearer's monitoring requirements. The head carrier is composed of an adjustable head band (11), which is prevented from slipping off by two additional bands (a longitudindal one (12) and a transverse one (13)). The lengths of those two additional bands are also adjustable, namely at their crossing point (14). In the area of the forehead, a support (9) is securely connected to the head band (11), with the holding piece (2) being rotatably fastened to the two arms of the latter. In the area of the back of the head, the current supply device (4) is housed, which may be provided either in the form of batteries or of rechargeable accumulators. Fitting just opposite the pivotable piece on the side of the forehead makes feasible an at least partial balancing of the weight and thus a decrease of the muscle strains in the back of the neck of the person wearing the lamp device. Current supply from the current supply device (4) to the light-emitting elements takes place via a bipolar line (6) which is conducted from the batteries, along the head band, across the right arm of the support, to a switch (5). That switch (5) is housed on the upper right in the holding piece (2) so that it may be operated effortlessly with the right hand while the lamp device is worn on the head.

With the arrangement according to the invention of the light-emitting elements (1), it is guaranteed that the light generated non-thermally with great efficiency is utilized as best as possible for the illumination of the monitoring or working areas, respectively. That leads to the fact that, on the one hand, the weight of the described headlamp may be kept minimally, since the energy sources and energy storage devices, respectively, necessary for the energy supply may have very small sizes, and, on the other hand, the disturbing generation of heat in front of or on the head of the wearer, respectively, is reduced to a minimum. That guarantees most comfortable wearing. Furthermore, the use of several light-emitting elements (1) guarantees that any tools and instruments which are used in the monitoring area while working with the described headlamp can block the illuminating light only partially, which is why sufficient illumination is ensured at all times.

1. A lamp device which is worn on the head, f.i., for medical applications in order to illuminate an area of treatment, characterized in that several non-thermal, light-emitting elements are provided as a light source, that the individual light-emitting elements emit the light in a defined direction of radiation and are located in such a way that the light which is generated is directional and that, in each case, several light-emitting elements are located on a support piece which is pivotable.

2. A headlamp according to claim 1, characterized in that the support piece is pivotable in a vertical direction.

3. A headlamp according to claim 1 or 2, characterized in that the support piece is pivotable in a horizontal direction.

4. A headlamp according to any one of the preceding claims, characterized in that all light-emitting elements are located on a single support piece.

5. A headlamp according to any one of the preceding claims, characterized in that the individual light-emitting elements (1) are located in such a way that the axis of radiation of each individual light-emitting element (1) may form an angle with the visual axis of a wearer in such a manner that the centre axis of radiation of all light-emitting elements has a common intersection point on the plane of symmetry of the wearer's eyes at the desired monitoring or working distance, respectively.

6. A headlamp according to any one of the preceding claims, characterized in that the individual light-emitting elements (1) are located in such a way that they all have the same distance to the illumination field.

7. A headlamp according to any one of the preceding claims, characterized in that it comprises an integrated energy supply device.
